(19) United States
(12) Patent Application Publication
(10) Pub. No.: US 2025/0373628 A1
(43) Pub. Date: Dec. 4, 2025

(54) RESPONDING TO SECURITY INCIDENTS USING LANGUAGE MODELS

(71) Applicant: Cisco Technology, Inc., San Jose, CA (US)

(72) Inventors: Mohammed Izzat Hamzeh, Anna, TX (US); Christopher Pieter van der Made, Rotterdam (NL); Christopher Shaun Roberts, Spring, TX (US)

(21) Appl. No.: 19/065,468

(22) Filed: Feb. 27, 2025

Related U.S. Application Data
(60) Provisional application No. 63/652,917, filed on May 29, 2024.

(51) Int. Cl. H04L 9/40

(52) U.S. Cl. CPC H04L 63/1416; H04L 63/1441

(57) ABSTRACT

Techniques for providing a language model to detect and remedy a security incident are described. A language model is deployed to respond to prompts from network operators. The language model receives a prompt from the network operator indicating actions to take based on trigger events. When a trigger event occurs, the language model receives a description of a potential security incident and identifies indicators of compromise in the description. The language model calls one or more other models to analyze the indicators and receives from the one or more other models, information indicating that the potential security incident is a real security incident, and outputs a prompt to the network operator to approve confirmation of the security incident.

### TECHNICAL FIELD

The present disclosure relates generally to provisioning language models in a detect and response system to automate the identification, containment, eradication, and recovery of a security incident.

### BACKGROUND

Detection and response security solutions are ever increasing in importance in today's cyber environment. Detection and response security solutions aim to detect any potential malicious or fraudulent activity perpetrated by cyber criminals in order to stop the activity, prevent the detected activity from happening again, and restore systems to a working state. Security Operations Centers (SOCs) are at the forefront of detection and response security solutions and are instrumental in defending organizational IT infrastructures from an array of cyber threats. SOCs are responsible for monitoring IT systems, identifying deviations from normal operations that may signify a potential security incident, and executing a series of steps to mitigate security incidents. The process, as outlined by frameworks like SANS “PICERL” (Preparation, Identification, Containment, Eradication, Recovery, and Lessons Learned) consists of phases that require meticulous manual effort by network operators, involving the collection of evidence, identification of the attack's root cause, determination of incident type and severity, isolation of affected network segments, eradication of malware, and careful reintroduction of systems to production environments.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a language model deployed in a detect and response system automates the review, identification, response and documentation of security incidents.

FIGS. 2A-2D collectively illustrate a flow diagram of an example method for using a language model to identify a potential security incident and confirm the incident as a true positive, contain the confirmed security incident, eradicate the confirmed security incident, and recover from the confirmed security incident.

FIG. 3 illustrates an example process flow for creating a customized security response plan utilizing a language model.

FIG. 4 illustrates an example user interface for creating a customized security response plan utilizing a language model.

FIG. 5 illustrates a flow diagram of an example method using a language model to identify a potential security incident and confirm the incident as a true positive.

FIG. 6 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to provisioning language models in a detect and response system to automate the identification, containment, eradication, and recovery of a security incident. A language model uses function calling to determine that a potential security incident is a true positive, and determining how to respond to the security incident, document the security incident, contain the security incident, and finally eradicate the security incident.

A first method described herein may include deploying a language model that is configured to respond to prompts from network operators associated with the network. Additionally, the first method may include receiving a prompt from a network operator indicating one or more actions to take based on predetermined trigger events occurring. The first method may further include determining that a predetermined trigger event occurred indicating a potential security incident. Further, the first method may include receiving, by the language model, a description of the potential security incident. The first method may also include determining, by the language model, indicators of compromise identified in the description. Additionally, the first method may include receiving, by the language model and from the one or more second models, information indicating that the potential security incident is a real security incident. Finally, the first method may include outputting, in response to receiving the information and by the language model, a prompt to the network operator to approve confirmation of the real security incident.

Additionally, the techniques of at least the first method and the second method and any other techniques described herein, may be performed by a system and/or device having non-transitory computer-readable media storing computer-executable instructions that, when executed by one or more processors, performs the method(s) described above.

### Example Embodiments

As described above, conventional detect and response systems required meticulous manual effort by Network operators, involving the collection of evidence, identification of the attack's root cause, determination of incident type and severity, isolation of affected network segments, eradication of malware, and careful reintroduction of systems to production environments. This manual approach to incident response presents several challenges. 1) Time Delay and Scalability: Manual intervention is time-consuming and may not scale well with the volume of incidents, potentially leading to delayed responses and increased vulnerability windows. 2) Consistency and Accuracy: Human analysis is subject to variability and can lead to inconsistent responses. Additionally, the complex nature of modern cyberattacks may exceed the detection and analysis capabilities of human operators, leading to oversight or misclassification of threats. 3) Resource Intensity: The manual effort required for thorough incident response strains SOC resources, diverting valuable human capital from strategic tasks to repetitive, operational activities. In addition, the amount of available talent and skill to use on this endeavor may be lacking, and less skilled individuals can lead to poor results, and ultimately, an unsecured networks, devices, applications, and cloud services. 4) Evolving Threat Landscape: The rapidly evolving nature of cyber threats makes it challenging for SOC teams to stay ahead of new tactics, techniques, and procedures (TTPs) employed by malicious entities, often requiring continuous training and knowledge updates which can be resource intensive. Malicious entities often resort to artificial intelligence (AI)-based attacks, making it even more difficult for SOCs to keep up.

Various types of virtual agents have emerged over the years with the purposes of interacting with and providing assistance to users as though they are human assistants. One type of virtual agent, known as a chatbot, is a computer program that has conversations with users through text or speech. Traditionally, chatbots operated under rule-based systems where rules and decision trees were used to recognize specific words or phrases provided by users, and provide predefined responses to the users based on these words or phrases. However, these chatbots were fairly limited and had difficulties handling unexpected or complex queries from users. Thus, while rule-based chatbots could handle basic tasks, these chatbots had fairly limited usefulness and provided little value for users.

More recently, there have been advances in AI that have enabled chatbots and other AI systems to perform complex tasks that normally require human intelligence. Generative AI is a type of artificial intelligence where models are used to create (or “generate”) new content based on inputs, often in the form of prompts from users. One type of generative AI model is particularly effective at generating text, specifically, the language model (e.g., the large language model (LLM)). Language models are trained on large sets or corpuses of text data to perceive and infer context from user queries, understand a broader range of queries, and generate human-like textual responses to the queries. Chatbots that are backed by language models are becoming increasingly popular among users due to their ability to perform complex tasks on behalf of users.

This disclosure describes techniques that provide for a highly customizable, AI-driven platform for incident response in cybersecurity by offering flexibility and dynamic adaptation beyond traditional methods. Generative AI models are used to analyze potential security incidents and identify whether those security incidents are real security incidents or false positives. Generative AI and function calling are used to respond to confirmed security incidents, document them, contain the incidents and finally eradicate the security incidents. The techniques described herein provide for an automated process for identification, containment, eradication, and recovery from security incidents using generative AI with human oversight. Each phase in the process (e.g., identification) can be automated with generative AI, using the ability to execute custom functions, and the findings confirmed or approved by a human, if desired, prior to moving on to the next phase of the process. Language models may be utilized according to the techniques described herein to replace (or augment) and assist network operators in the identification, containment, and eradication of a security incident and the recovery of a system from the security incident. Network operator is used herein as an example and is not meant to be limiting. Terms such as network administrator, SOC engineer, SOC administrator, SOC personnel, incident responders, analysts, etc. may also be used in association with the techniques described herein.

Customizable response plan templates are used to customize each phase of a response plan, tailoring actions to specific incident types and organizational needs. Each phase of the response plane may consist of multiple steps. The templates may be used as instructions to a language model (e.g., an LLM). Text input to the templates may contain instructions that will initialize the language model, defining its tasks. Additionally, the language model may be equipped with the ability to execute specific functions, such as data lookups and system remediation, directly within the response workflow. In some examples, functions can be set to require a human to approve the functions execution, alternately function may be configured to run automatically.

The steps defined in each phase of an incident response plan may be configured for chaining responses, where the output of one step can dynamically inform the actions of subsequent steps, ensuring a coherent and contextually aware incident response. This may be achieved using variable references in the templates created. Users are provided with predefined response steps in line with SANS incident response framework, however, users may also design incident response strategies, including the automation of actions based on incident severity or other criteria, without being restricted to specific detection and response platforms. Once a response plan has been created, the platform utilizes advanced triggering mechanisms based on incident characteristics to automatically initiate customized response plans, enhancing timely and accurate incident management.

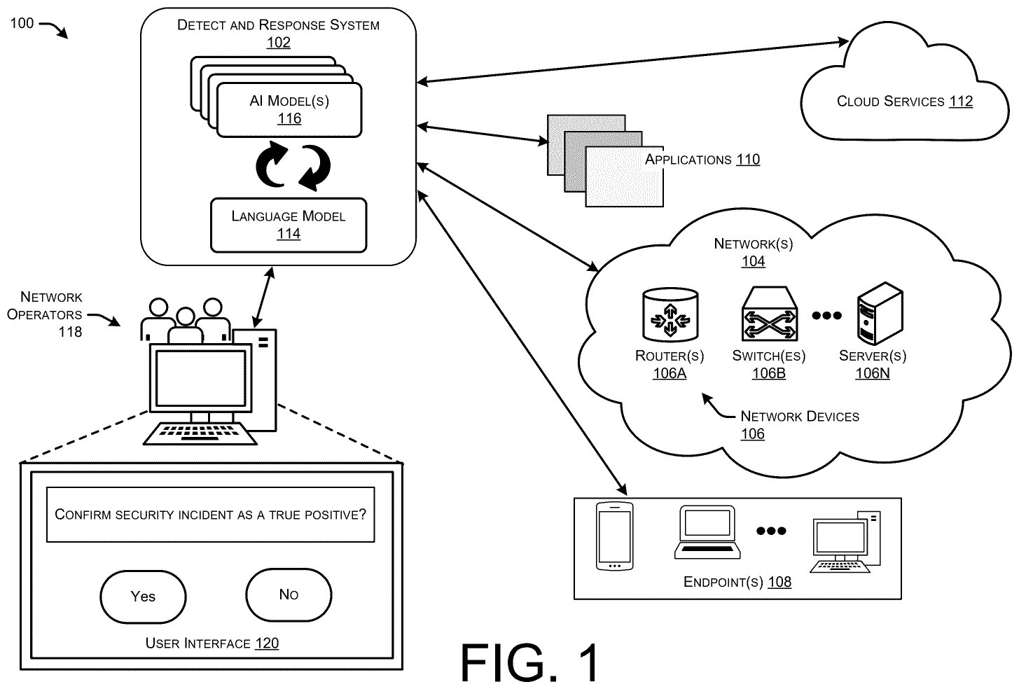

FIG. 1 illustrates a system-architecture diagram of an environment in which a language model deployed in a detect and response system automates the review, identification, response and documentation of security incidents.

The environment 100 may include a detect and response system 102. The detect and response system 102 may collect telemetry from multiple source, may apply analytics on the collected telemetry to detect malicious activity and respond to the malicious activity. Although conventional detect and response systems may automatically monitor and collect telemetry, there is considerable manual labor involved in the identification, containment, eradication, and recovery of a system when a malicious activity occurs. Environment 100 also include a network 104 implemented by any viable communication technology, such as wired and/or wireless modalities and/or technologies. The network 104 may be any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network 104 may include devices, virtual resources, or other nodes that relay packets from one network segment to another by nodes in the computer network. The network 104 may include multiple devices that utilize the network layer (and/or session layer, transport layer, etc.) in the OSI model for packet forwarding, and/or other layers. The network 104 may include various network devices 106, such as routers 106A, switches 106B, gateways, firewalls, smart NICs, NICs, ASICs, FPGAs, servers 106N, and/or any other type of device. Further, the network 104 may include virtual resources, such as VMs, containers, and/or other virtual resources. However, the network 104 may be of a different type of architecture, such as a WAN, IoT network, cellular network, or any other type of network.

Environment 100 also includes one or more endpoints 108. Endpoints 108 may be a conventional server computer, workstation, desktop computer, laptop, tablet, network appliance, e-reader, smartphone, IoT endpoint, or any other appropriate type of electronic device that may connect to network 104. Environment 100 also include applications 110 that may execute on electronic devices, such as network device 106 or endpoints 108. Environment 100 may also include one or more cloud services 112, such as resources and service hosted by third parties that the endpoints 108 may access via the network 104. The detect and response system 102 may monitor and collect endpoint telemetry, network telemetry (both cloud and physical), applications telemetry, user identities, etc. to detect threats and potential malicious activity in environment 100.

Environment 100 also include a language model 114 and one or more other AI model(s) 116. A network operator(s) 118 may connect with the detect and response system 102 via one or more user interfaces 120 and once authenticated, can interact with the user interface 120 to issue prompts and commands for creating an enterprise organization incident response procedure. The interfaces 120 may be web-based portals, application interfaces, websites, CLIs, APIs, and/or any other interface through which data may be communicated. According to the techniques described herein, the user interface(s) 120 may receive prompts or other data from the network operators 118 via text interfaces or other interactable elements as shown.

The language model 114 may be configured for function calling, the ability to call external tools to enable effective tool usage and interaction with external APIs. As illustrated in environment 100 the language model 114 may call one or more of the AI model(s) 116 to execute actions associated with the identification, containment, eradication, and recovery from a security incident. In addition, the language model is configured to prompt a network operator 118 for approval to continue between each phase of the incident response process, thus, providing automation with human oversight, customizable based on the policies and procedures of an enterprise organization.

There have been advances in artificial intelligence (AI) that have enabled chatbots and other AI systems to perform complex tasks that normally require human intelligence, such as perceiving, synthesizing, and inferring information. Generally speaking, AI systems and models ingest large amounts of data (or “training data”), analyze this data to identify correlations and patterns, and use these patterns to make predictions about future states. Although AI programs and algorithms have been around for decades, the amount of data and computing power needed to train AI models that are useful for humans has not existed. However, there have been various technological breakthroughs and advances that have accelerated the usefulness of AI, such as advent of cloud computing that provides effectively unlimited compute, advances in specialized hardware (e.g., graphics processing units (GPUs)) that efficiently train and run these AI models, and the discovery of more efficient training algorithms.

Generative AI is a type of artificial intelligence where models are used to create (or “generate”) new content based on inputs, often in the form of prompts from users. One type of generative AI model is particularly effective at generating text, specifically, the large language model (LLM). Language models 114 are trained on large sets or corpuses of text data to perceive and infer context from user queries, understand a broader range of queries, and generate human-like textual responses to the queries and determine appropriate function to call to acquire needed information. Chatbots that are backed by language models 114 are becoming increasingly popular among users due to their ability to perform complex tasks on behalf of users.

One type of neural network architecture that has gained popularity due to its ability to reduce the amount of time needed to train generative AI models is known as the Transformer model, or simply “Transformers.” Transformers apply a set of mathematical techniques, called attention or self-attention, to capture relationships in sequential data called tokens, such as words in a sentence. Transformers are able to detect subtle causal relationships between data elements in a series, including how even distant data elements influence and depend on each other. Unlike previous models that have to process tokens sequentially (e.g., Recurrent Neural Networks (RNNs)), transformers use an attention mechanism to process tokens simultaneously and calculate the attention weights, or strengths of relationships, between the tokens in successive layers. Because transformers can compute attention weights for all the tokens in parallel, the amount of time needed to train generative AI models using transformers is greatly improved over other training models.

Generative AI can be used to generate text that resembles human-like responses to prompts. Transformers are very effective in training the models used generate text, often referred to as language models 114. Language models 114 are trained on large sets or corpuses of text data to generate human-like textual responses to prompts. Language models 114 are generally trained in two stages, pre-training and fine-tuning. During the pre-training stage, language models 114 are trained on massive datasets of unlabeled text data (or “unsupervised learning”) where transformers allow the language models 114 to process and learn the patterns and relationships between words. During the fine-tuning stage, the language models 114 can be fine-tuned for specific tasks or prompts, such as summarizing content, answering questions, and text completion. There are generalized language models 114 that have been trained on sets of text data describing all types of content (e.g., data obtained from crawlers that scrape the public Internet). There are also specialized language models 114 that have been trained on specialized sets of data that are specific to a particular type of content, such as networking technology.

The language model 114 may simply be an off-the-shelf language model that is deployed to the detect and response system 102, but in other examples, the language model 114 may be fine-tuned for security incident response in general, and potentially fine-tuned for the specific enterprise organizations network architecture, policies, and procedures. The language model 114 may also be fine-tuned to detect when a function needs to be called. Function calling enables the language model 114 to connect with external tools that the language model can intelligently select and invoke to accomplish a given task.

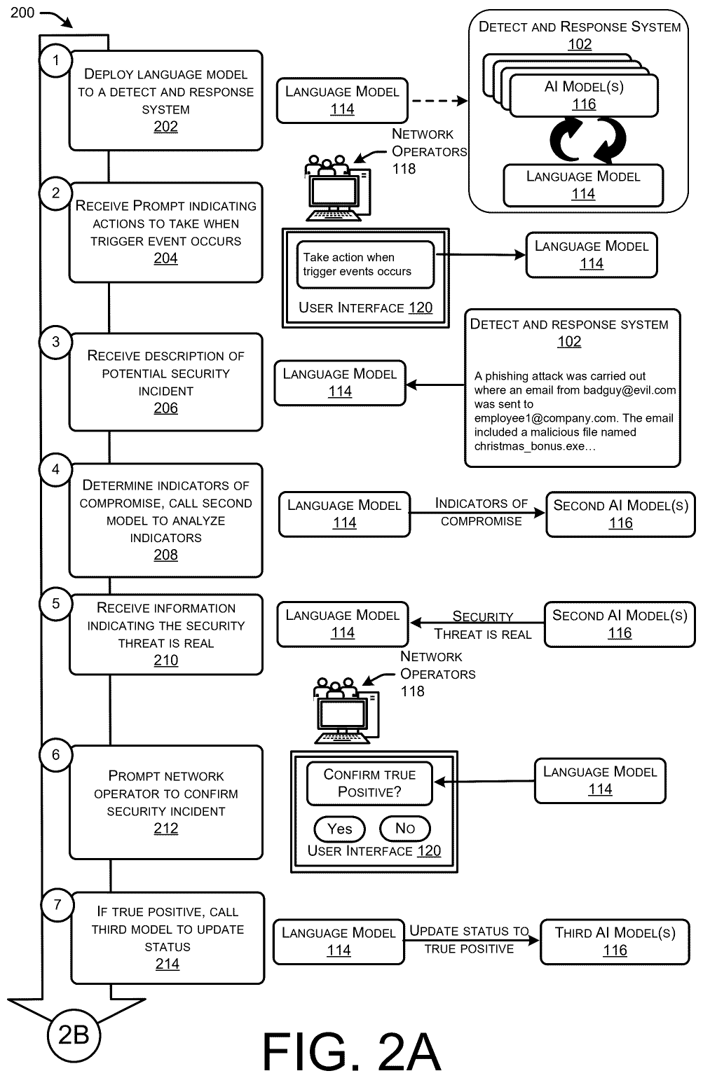

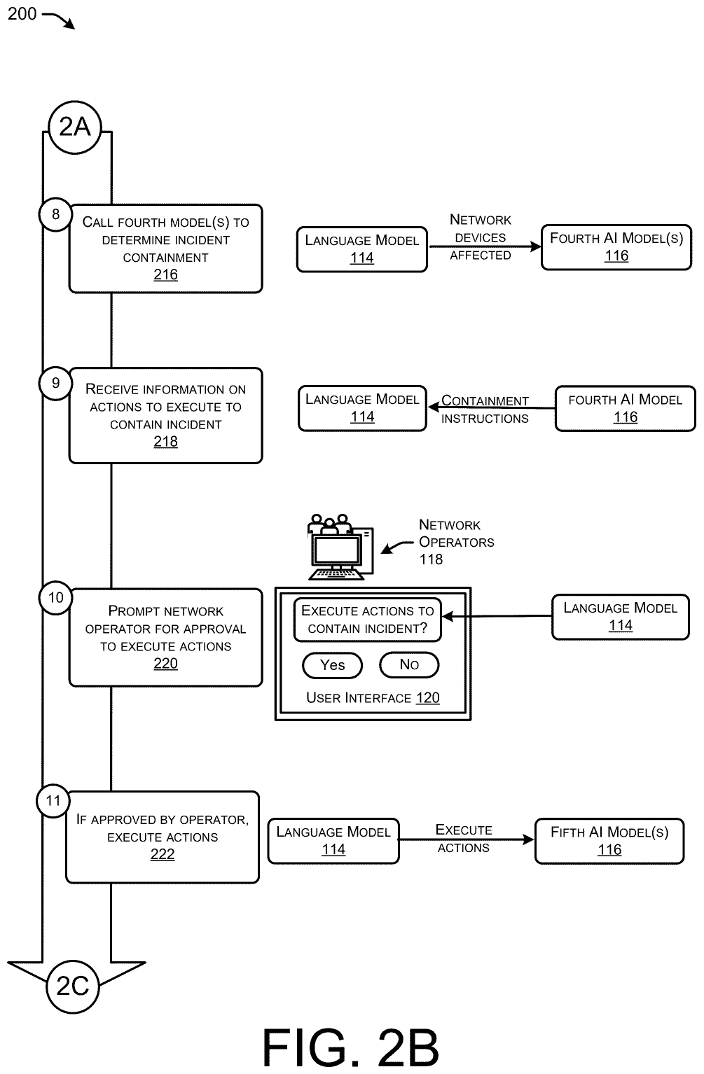

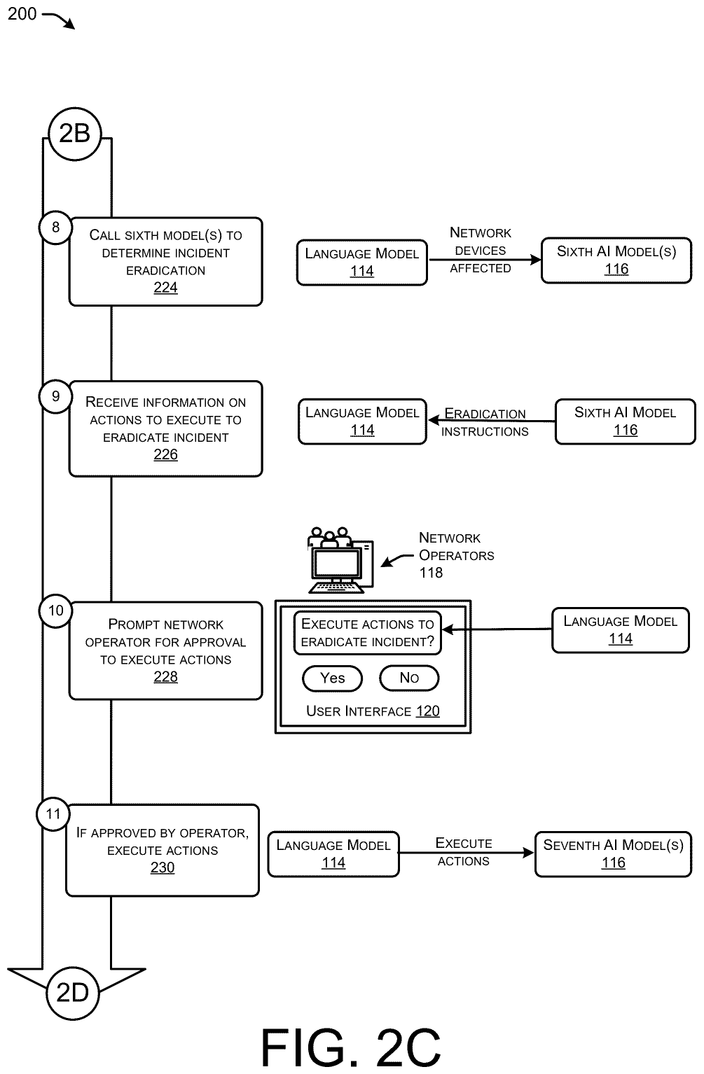

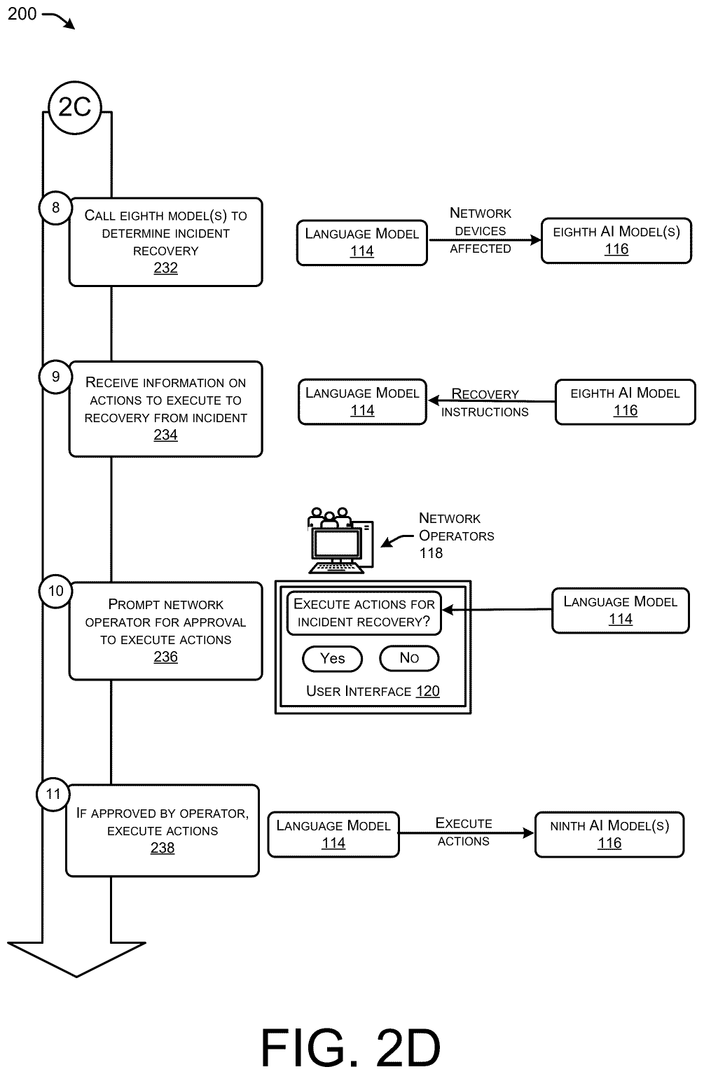

FIGS. 2A-2D collectively illustrate a flow diagram 200 of an example method for using a language model to identify a potential security incident and confirm the incident as a true positive, contain the confirmed security incident, eradicate the confirmed security incident, and recover from the confirmed security incident.

FIG. 2A generally illustrates the portion of flow diagram 200 for using the language model to identify a potential security incident and confirm the incident as a true positive.

At 202, a language model 114 may be deployed to a detect and response system 102. By deploying a language model to the detect and response system, flexibility and dynamic adaptation beyond traditional methods are enabled for incident response in cybersecurity. The language model is used as a conduit between a network operator and other AI models and/or functions to automate the analyzing of potential security incidents, identify whether the potential security incidents are confirmed or false positives, respond to confirmed security incidents, document them, contain the incidents, eradicate the incidents, and finally ensure system recovery.

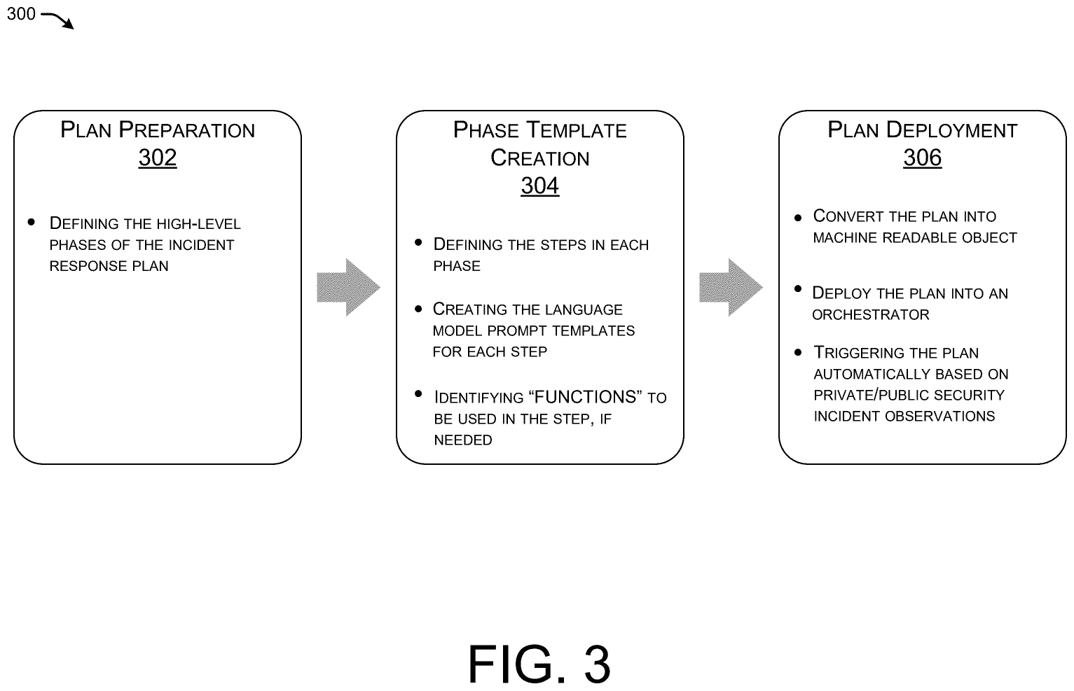

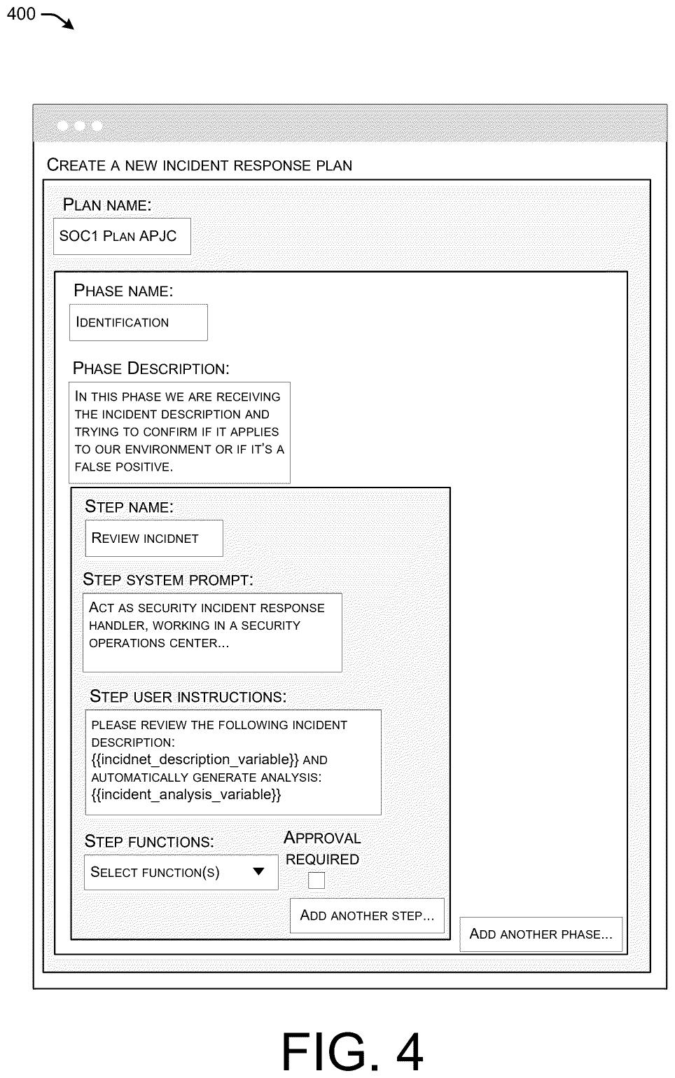

At 204, the language mode 114 receives a prompt from a network operator 118 indicating one or more actions to take when a predetermined trigger event occurs. To initialize the system, a network operator can define each phase in a response system by following a SANS framework or building their own custom response plan tailored to their organization. Each phase in the response plan may have multiple steps. The network operator may create templates for each step that will be used as instructions to the language model and support variable reference capabilities. Response plan creation and templates will be discussed in further detail below with reference to FIG. 3 and FIG. 4.

At 206, the language model 114 may receive a description of a potential security incident via the detect and response system 102. When the detect and response system 102 detects a potential security incident, it will input a natural language description of the incident to the language model 114. The example illustrated at 206 includes a description of a potential phishing attack detected within an enterprise organization.

At 208, the language model 114 determines indicators of compromise identified in the description, and calls one or more second AI model(s) 116 to analyze the indicators of compromise. The language model 114 analyzes the natural language description received at 206 and identifies indicators of compromise in the description and initiates a function call to analyze the indicators and determined whether the detected potential security incident is a real security incident or a false positive. Alternately, the language model 114 may, itself, determine whether the detected potential security incident is a real security incident of a false positive.

At 210, the language model 114 receives information indicating that the potential security incident is a real security incident from the one or more second AI model(s) 116. The second AI model(s) 116 that the language model 114 called in step 208 determined whether the potential security incident is a real security incident or not, and if the potential security incident is determined to be a true positive, this information is input back into the language model 114. In addition, the one or more second AI model(s) 116 may determine hosts found with malicious indicators that have been affected by the potential security incident.

At 212, the language model 114 prompts the network operator 118 to approve that the security incident is a true positive via the user interface 120. If the potential security incident has been determined to be a true positive by the function called in step 208, the language model 114 may be configured to output a prompt to the network operator 118 to approve confirmation that the potential security incident is a true positive. Alternately, in some instances, the language model 114 may not be configured to prompt the network operator 118, and may continue to step 214 automatically without user input.

At 214, if the network operator 118 approves confirmation that the incident is a true positive, the language model 114 calls a third AI model 116 to update the status of the potential security incident to true positive in the detect and response system 102. If the language model 114 is configured to prompt the network operator 118 to approve confirmation that the security incident is a true positive, and the network operator 118 approves the true positive, the language model 114 calls another function (e.g., a third AI model(s) 116) to update the status of the potential security incident to a true positive in the detect and response system 102. Alternately, if the language model 114 is not configured to prompt the network operator 118 to approve confirmation of the security incident, the language model 114 may automatically call the function to update the status without user input or approval.

FIG. 2B generally illustrates the portion of flow diagram 200 for using the language model to contain the security incident that was confirmed in FIG. 2A.

At 216, the language model 114 may call one or more fourth AI model(s) 116 to determine how to contain the confirmed security incident. Once the potential security incident has been identified and confirmed as a true positive, the next step in a SANS framework is to contain the security threat. Note, this is by example and not limitation, as the techniques described herein may be customized and tailored to an enterprise organizations particular needs, policies, and procedures, which may deviate from a typical SANS framework. The information received by the language model from the one or more second AI model(s) 116 above in step 210 may include information indicating network devices that are affected by the security incident. The language model 114 may be configured to determine additional functions to call (e.g., one or more fourth AI model(s) 116) to determine how to contain the security incident.

At 218, the language model 114 may receive information on actions to execute to contain the security incident from the one or more fourth AI model(s) 116 called in step 216. For example, the information may include how to isolate the affected network devices, disable affected user accounts, prevent further damage from the security incident, and/or any other appropriate actions that will assist in containing the damage from the security incident.

At 220, the language model 114 may prompt a network operator 118 for approval to execute actions determined in step 218. Alternately or in addition, some or all of the actions may be initiated automatically without user approval depending on severity or other factors determined by the enterprise organization and customized into their particular incident response plan.

At step 222, the language model may call one or more fifth AI model(s) 116 to execute the actions to contain the security incident. Because the functions are built to be general purpose and have a predefined set of inputs, the language model 114 is responsible for providing the inputs to each function. For example, in the containment phase, an example action to execute may be to contain a specific IP address. The language model 114 may be provided with a function to create access control lists (ACL's) on the environment firewall, and the inputs of that function may be protocol (e.g., IP, TCP, UDP, etc.) source IP, destination IP, and destination port. The language model 114 may determine to contain a specific IP by running the function and providing the needed inputs. Alternately, if the language model 114 is not configured to prompt the network operator 118 to confirm the action to execute to contain the security incident, the language model 114 may automatically call the functions to contain the security incident without user intervention or approval.

FIG. 2C generally illustrates the portion of flow diagram 200 for using the language model to eradicate the security incident that was contained in FIG. 2B.

At 224, the language model 114 may call one or more sixth AI model(s) 116 to determine how to eradicate the confirmed security incident. Once the security incident has been contained, the next step in a SANS framework is to eradicate the security threat. The information received by the language model from the one or more second AI model(s) 116 above in step 210 may include information indicating network devices that are affected by the security incident. The language model 114 may be configured to determine additional functions to call (e.g., one or more sixth AI model(s) 116) to determine how to eradicate the security incident.

At 226, the language model 114 may receive information on actions to execute to eradicate the security incident from the one or more sixth AI model(s) 116 called in step 224. For example, the information may include how to remove malicious software, patch vulnerable systems, restore affected data, and/or any other appropriate action that will assist in eradicating the damage from the security incident.

At 228, the language model 114 may prompt a network operator 118 for approval to execute actions determined in step 226. Alternately or in addition, some or all of the actions may be initiated automatically without user approval depending on severity or other factors determined by the enterprise organization and customized into their particular incident response plan.

FIG. 2D generally illustrates the portion of flow diagram 200 for using the language model to recover from the security incident that was eradicated in FIG. 2C.

At step 230, the language model may call one or more seventh AI model(s) 116 to execute the actions to eradicate the security incident. Alternately, if the language model 114 is not configured to prompt the network operator 118 to confirm the action to execute to eradicate the security incident, the language model 114 may automatically call the functions to eradicate the security incident without user intervention or approval.

At 232, the language model 114 may call one or more eighth AI model(s) 116 to determine how to recover from the confirmed security incident. Once the security incident has been eradicated, the next step in a SANS framework is to recover from the security incident. The information received by the language model from the one or more second AI model(s) 116 above in step 210 may include information indicating network devices that are affected by the security incident. The language model 114 may be configured to determine additional functions to call (e.g., one or more eighth AI model(s) 116) to determine how to recover from the security incident.

At 234, the language model 114 may receive information on actions to execute to recover from the security incident from the one or more eighth AI model(s) 116 called in step 232. For example, the information may include how to restore systems to a known good state, validate that the real security incident has been resolved, and/or any other appropriate action that will assist in restoring the damage from the security incident.

At 236, the language model 114 may prompt a network operator 118 for approval to execute actions determined in step 234. Alternately or in addition, some or all of the actions may be initiated automatically without user approval depending on severity or other factors determined by the enterprise organization and customized into their particular incident response plan.

At step 238, the language model may call one or more ninth AI model(s) 116 to execute the actions to recovery from the security incident. Alternately, if the language model 114 is not configured to prompt the network operator 118 to confirm the action to execute to recovery from the security incident, the language model 114 may automatically call the functions to recover the security incident without user intervention or approval.

FIG. 3 illustrates an example process flow 300 for creating a customized security response plan utilizing a language model. Beyond predefined response steps, users have freedom to design their incident response strategy, including automations of actions based on incident severity or other criteria, without being restricted to specific detection and response platforms. This approach ensures a faster, more precise, and tailored response to security incidents, significantly improving efficiency and effectiveness in handling cybersecurity threats.

The first step in creating a customized security response plan is plan preparation 302. In this step the high-level phases of an incident response plan are determined. For example, if an enterprise organization wants to follow a SANS framework, the phases defined may be 1) identification 2) containment 3) eradication, and 4) recovery. Although used herein as an example of phases to implement in a security response plan, these phases are an example and not meant to be limiting, as each enterprise organization may design a response plan customized to their own needs based on organization policies and procedures.

Once the phases in a response plan are defined, the next step in the security response plan creation process is phase template creation 304. In this step, the steps in each phase are determined, the language model prompt templates for each step are created, and “functions” are identified that may be used in each step if needed. Consider for example, a network operator, that defines an “identification” phase during plan preparation 302. under the “identification” phase several step may be included during the phase template creation 304 process. At a high level this may be represented as follows:

```
Phase Name: Identification
Steps:
  Review Incident
  Put Compromised Accounts on Monitoring
  Investigate and analyze Incident Observables, For Example:
    List Hosts Who Communicated with External Domain(s), IP(s), and URL(s)
  If Email Related Attack Vector:
    List Users Who Opened Email Message
    Collect Email Message
    List Email Message Receivers
    Make sure Email Message is Malicious
    Extract Observables from Email Message
    ect.
  Confirm/Reject Incident
  Document and Notify (e.g., create ticket and send IM notification)
  Continue to Containment Phase
```

In each step the language model may be provided with functions that may be called. The functions are tools the model can use to perform actions on the environment, these functions are pre-built by a network operators. Examples of how some functions might be used are to add notes into the ticketing system, create an access list on one or multiple firewalls, send an email to specific email addresses or a pre-defined set of mailers, etc. The functions are built to be general purpose and have a pre-defined set of inputs. The language model can make a decision to execute the function or not. If the language model makes the decision to execute the function, the language model is responsible for providing the inputs to each function. The functions must be properly defined, described, and documents so the language model is able to understand each individual function and its usage.

An example function during a “containment” phase of the recovery plan may be to execute a step to contain a specific IP address. The language model in that step is provided a function to create ACL's on the environment firewalls. The inputs of that function are protocol (e.g., IP, TCP, UDP, etc.), source IP, destination IP, and destination port. Based on the detected incident and the analysis to this point in the incident recovery plan process, the language model can decide to contain a specific IP by running this function and providing the needed inputs.

Finally, a network operator can configure each function to require human approval. A default setting for each function is that they require a human to approve the function execution. However, the process can be customized to not require a human to approve the function execution for one or more of the functions based on an enterprise organizations particular desires. The network operator can define further orders of operations. Such as: action 1 must always be first, or action 3 must never come after action 1. The network operator may also determine if steps are to be run together in an “and” setup or either one in an “or” setup. These order of operations can be defined in a similar way to mathematical or logical order of operations.

Once the different phases and steps in the incident response plane are created during plans preparation 302 and phase template creation 304, plan deployment 306 is initiated and the incident response plan can be submitted for automated handling of security incidents. Plan deployment 306 consists of converting the plan into machine readable objects (e.g., Json, Yaml, etc.), deploying the plan into an orchestrator, and triggering the plan automatically based on private/public security incident observations.

For example, the following is a Yaml example of converting the plan into machine readable objects.

```
  type: incident response
  name: soc1 plan
  phases:
  -name: identification
  description: in this phase we are reviewing the incident and trying to confirm if it applies
to our environment or if it is a false positive.
  steps:
  -name: review incident
  system_instructions: act as security incident response handler, working in an SOC ...
  user_instructions: Incident Description: {{incident_description_variable}}
  function_calling: true
  functions:
  -get_incident_details
  -add_note
  -name: containment:
  ...
```

After the plan is converted to machine consumable objects, it is passed down to an orchestration engine that is responsible for executing each phase, step by step by passing the incident data, system instructions template, and user instructions template to the language model. After all the steps in a phase are executed, a summary of the phase execution may be generated using the language model. This is done by providing the language model with the outputs from the steps that were executed, and instructing the model to generate a phase execution summary. The orchestration engine will move to the next phase in the plan, and the phase execution summary will be provided to the model running the first step in the next phase. In this way the models can maintain context of what was done in previous phases and results of those previous phases.

FIG. 4 illustrates an example user interface 400 for creating a customized security response plan utilizing a language model. User interface 400 includes example templates for phase template creation 304 as described with reference to FIG. 3. User interface 400 shows an example of how a network operator may create a new incident response plan. A new plan name “SOC1 Plan APJC” is being created. A first phase “identification” is shown. A description for the identification phase is input, in this example the phase description indicates that a description of an incident will be received and a determination of whether the incident is real and applies to the enterprise organization environment is to be made. A first step in this phase is “Review Incident” and instructs the language model to act as a security incident response handler, and provides a text box to input step user instructions, and a pull-down menu to select one or more functions that may be called in this step. Also illustrated is a checkbox to indicate whether human approval is required. If this box is checked, the language model will prompt a network operator for approval to proceed. Once this current step template is completed, the network operator may add another step to the phase by clicking the “add another step button. Similarly, once all the steps in the phase currently being created are complete, the network operator may “add another phase” to the incident response plan by selecting the associated selectable button. User interface 400 is an example and is not meant to be limiting, any appropriate type of user interface having various interactable elements (e.g., text boxes, pull-down menus, check boxes, clickable buttons, etc.) for customizing an incident response plan may be used.

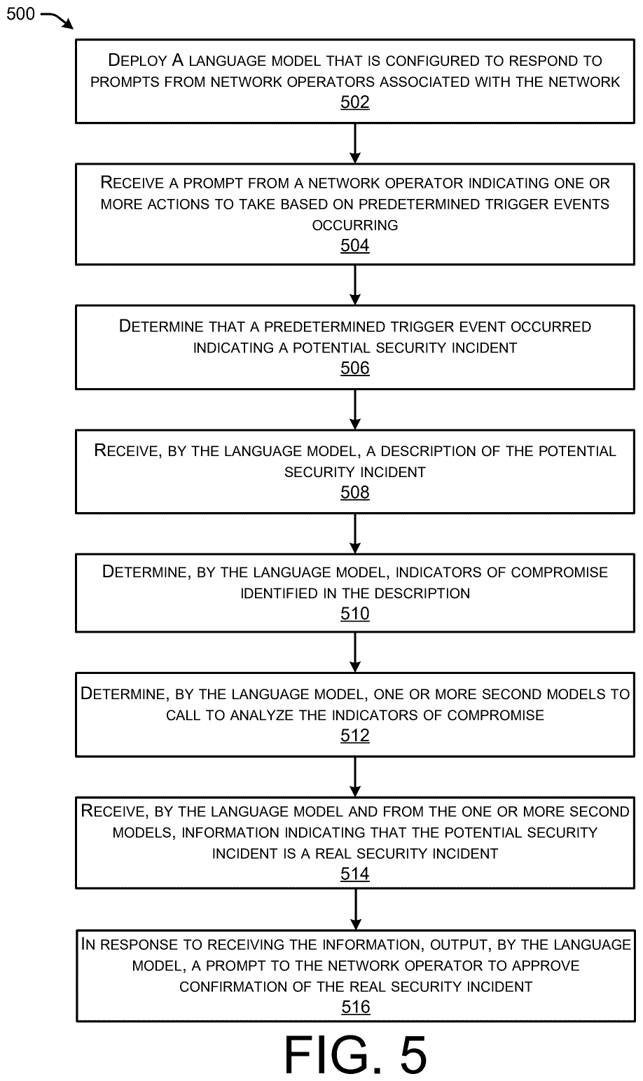

FIG. 5 illustrates a flow diagrams of an example method 500 that illustrates aspect of the functions performed at least partly by the devices described in FIGS. 1-4, such as the language model 114 and the AI model(s) 116. The logical operations described herein with respect to FIG. 5 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 5 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 500 may be performed by a device and/or a system of devices that includes one or more processors and one or more non-transitory computer-readable media storing computer-executable instructions that, when executed by the one or more processors, cause the one or more processors to perform operations of method 500.

FIG. 5 illustrates a flow diagram of an example method 500 for using a language model to identify a potential security incident and confirm the incident as a true positive.

At operation 502, a language model is deployed that is configured to respond to prompts from network operators associated with the network. For example, with reference to FIG. 1 the language model 114 is deployed as part of the detect and response system 102. In some example the language model may be an LLM that utilizes natural language processing and serves as an interface between a network operator 118 and the detect and response system 102 as shown by the user interface 120. The language model 114 enables network operators 118 to build custom response plans tailored to their organization by providing custom instructions to the language model on how to handle each phase and step of an incident response plan.

At operation 504, the language model receives a prompt from a network operator indicating one or more actions to take based on predetermined trigger events occurring. For example, once the language model has been deployed in the detect and response system 102 network operator(s) 118 may input instructions indicating one or more actions to take when a trigger event occurs. For example, with reference to FIG. 2A at step (2) a network operator 118 may input instructions in the user interface 120 indicating an action to take when a trigger even occurs. Referring to FIG. 4, user interface 400 illustrates an example for response plan creation. As shown a network operator 118 may input instruction to the language model to review an incident and generate an analysis when a description of a potential security incident is received.

At operation 506, a determination that a predetermined trigger event occurred indicating a potential security incident is made. For example, with reference to FIG. 1, the detect and response system 102 continuously monitors an enterprise organizations network infrastructure for trigger events that indicate a potential security incident may or has occurred. When a trigger event is detected, the detect and response system 102 may take action according to instructions predetermined by network operators 118.

At operation 508, the language model receives a description of the potential security incident. For example, with reference to FIG. 1, once the detect and response system 102 determines a potential security incident has occurred at operation 506, an action the detect and response system may take is to send a description of the potential security event to the language model 114 as illustrated in step (3) of FIG. 2A.

At operation 510, the language model determines indicators of compromise identified in the description. Once the language model receives the description of the potential security incident, the language model analyzes the description and identifies indicators of compromise. For example, with reference to FIG. 2A at (3) the language model 114 receives the description of the potential security incident and at (4) the language model 114 analyzes the received description and determines indicators of compromise in the description.

At operation 512, the language model determines one or more second models to call to analyze the indicators of compromise. Once the language model has identified the indictors of compromise, the language model may call one or more other models or functions to analyze the indicators of compromise and determine whether the potential security incident is a real security incident of a false positive. For example, with refence to FIG. 1 the language model 114 may call one or more other AI model(s) 116 to analyze the indicators of compromise and determine whether the potential security incident is a real security incident of a false positive.

At operation 514, the language model receives information indicating that the potential security incident is a real security incident from the one or more second models. For example, with reference to FIG. 1, the one or more AI model(s) 116 may determine that the potential security incident is a real security incident (or is a false positive) and input this information into the langue model 114. With reference to FIG. 2A, at (5) the second AI model(s) 116 input information into the language model 114 that indicates the security threat is real and the potential security incident is a true positive.

At operation 516, in response to receiving the information, the language model outputs a prompt to the network operator to approve confirmation of the real security incident. For example, with reference to FIG. 1, the language model 114 prompts a network operator 118 to “confirm security incident as a true positive” via user interface 120 as illustrated. Once a network operator confirms the incident as a true positive, the language model may call one or more additional models of functions to update a status of the potential incident to a true positive in the detect and response system. Alternately, in some instances, the language model may not prompt a human (e.g., network operator 118) to confirm the incident as a true positive, and may call the function to update the incident to a true positive automatically. Techniques described herein are customizable and individual enterprise organizations may customize the system to act according to their preferences.

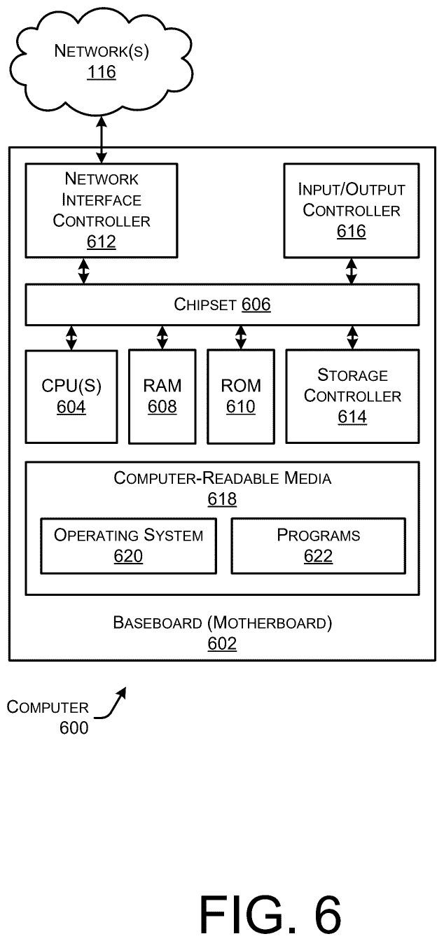

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein.

As described herein, the computer 600 may be any type of device, such as network devices 106 or endpoints 108. Thus, the computer 600 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network 104. The chipset 606 can include functionality for providing network connectivity through a NIC 612, such as a gigabit Ethernet adapter. The NIC 612 is capable of connecting the computer 600 to other computing devices over the network 104. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the network devices 106, the endpoints 108, the device(s) operated by the network operators 118 with user interface 120, and or any components included therein, may be supported by one or more devices similar to computer 600. Stated otherwise, some or all of the operations performed by network devices 106, the endpoints 108, and/or device(s) operated by the network operators 118 having user interface 120, and or any components included therein, may be performed by one or more computer devices 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in the Figures, can include other components that are not explicitly shown in FIG. 6, or might utilize an architecture completely different than that shown in FIG. 6.

As described herein, the computer 600 may comprise one or more of the network device 106, endpoints 108 and/or any other device. The computer 600 may include one or more hardware processors 604 (processors) configured to execute one or more stored instructions. The processor(s) 604 may comprise one or more cores. Further, the computer 600 may include one or more network interfaces configured to provide communications between the computer 600 and other devices, such as the communications described herein as being performed by the network devices 106, the endpoints 108 and/or the devices operated by the network operators 118 with user interface 120. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for utilizing a language model to detect and remedy a security incident in a network, the method comprising:
deploying the language model that is configured to respond to prompts from network operators associated with the network;
receiving a prompt from network operator indicating one or more actions to take based on predetermined trigger events occurring;
determining that a predetermined trigger event occurred indicating a potential security incident;
receiving, by the language model, a description of the potential security incident;
determining, by the language model, indicators of compromise identified in the description;
determining, by the language model, one or more second models to call to analyze the indicators of compromise;
receiving, by the language model and from the one or more second models, information indicating that the potential security incident is a real security incident; and
in response to receiving the information, outputting, by the language model, a prompt to the network operator to approve confirmation of the real security incident.

2. The method of claim 1 further comprising:
based at least in part on receiving approval from the network operator, calling a third model to update a status of the real security incident to a true positive.

3. The method of claim 2, wherein the approval from the network operator is automated and does not require user input.

4. The method of claim 2, wherein the information received from the one or more second models include network devices that are affected by the real security incident, and further comprising:
calling, by the language model, one or more fourth models to call to determine how to contain the real security incident;
receiving, by the language model from the one or more fourth models, information on actions to execute to contain the real security incident including actions to execute to (i) isolate the affected network devices, (ii) disable affected user accounts, or (iii) prevent further damage from the real security incident;
outputting, by the language model, a prompt to the network operator for approval to execute the actions; and
in response to receiving approval, calling one or more fifth models to execute the actions.

5. The method of claim 4, further comprising:
determining, by the language model, one or more sixth models to call to determine how to eradicate the real security incident;
receiving, by the language model from the one or more sixth models, information on actions to execute to eradicate the real security incident including actions to execute to (i) remove malicious software, (ii) patch vulnerable systems, or (iii) restore affected data;
outputting, by the language model, a prompt to the network operator for approval to execute the actions; and
in response to receiving approval, calling one or more seventh models to execute the actions.

6. The method of claim 5, further comprising:
determining, by the language model, one or more eighth models to call to determine how to recover from the real security incident;
receiving, by the language model from the one or more eighth models, information on actions to execute to recover from the real security incident including actions to execute to (i) restoring systems to a known good state, and (ii) validating that the real security incident has been resolved;
outputting, by the language model, a prompt to the network operator for approval to execute the actions; and
in response to receiving approval, calling one or more ninth models to execute the actions.

7. The method of claim 1, wherein the language model is a large language model (LLM).

8. A system comprising:
one or more processors; and
one or more computer-readable media storing computer-executable instructions that, when executed by the one or more processors, cause the one or more processors to perform operations comprising:
deploying a language model that is configured to respond to prompts from network operators associated with a network;
receiving a prompt from a network operator indicating one or more actions to take based on predetermined trigger events occurring;
determining that a predetermined trigger event occurred indicating a potential security incident;
receiving, by the language model, a description of the potential security incident;
determining, by the language model, indicators of compromise identified in the description;
determining, by the language model, one or more second models to call to analyze the indicators of compromise;
receiving, by the language model and from the one or more second models, information indicating that the potential security incident is a real security incident; and
in response to receiving the information, outputting, by the language model, a prompt to the network operator to approve confirmation of the real security incident.

9. The system of claim 8, the operations further comprising:
based at least in part on receiving approval from the network operator, calling a third model to update a status of the real security incident to a true positive.

10. The system of claim 9, wherein the approval from the network operator is automated and does not require user input.

11. The system of claim 9, wherein the information received from the one or more second models include network devices that are affected by the real security incident, and the operations further comprising:
calling, by the language model, one or more fourth models to call to determine how to contain the real security incident;
receiving, by the language model from the one or more fourth models, information on actions to execute to contain the real security incident including actions to execute to (i) isolate the affected network devices, (ii) disable affected user accounts, or (iii) prevent further damage from the real security incident;
outputting, by the language model, a prompt to the network operator for approval to execute the actions; and
in response to receiving approval, calling one or more fifth models to execute the actions.

12. The system of claim 11, the operations further comprising:
determining, by the language model, one or more sixth models to call to determine how to eradicate the real security incident;
receiving, by the language model from the one or more sixth models, information on actions to execute to eradicate the real security incident including actions to execute to (i) remove malicious software, (ii) patch vulnerable systems, or (iii) restore affected data;
outputting, by the language model, a prompt to the network operator for approval to execute the actions; and
in response to receiving approval, calling one or more seventh models to execute the actions.

13. The system of claim 12, the operations further comprising:
determining, by the language model, one or more eighth models to call to determine how to recover from the real security incident;
receiving, by the language model from the one or more eighth models, information on actions to execute to recover from the real security incident including actions to execute to (i) restoring systems to a known good state, and (ii) validating that the real security incident has been resolved;
outputting, by the language model, a prompt to the network operator for approval to execute the actions; and
in response to receiving approval, calling one or more ninth models to execute the actions.

14. The system of claim 8, wherein the language model is a large language model (LLM).

15. One or more non-transitory computer-readable media storing instructions that, when executed, cause one or more processors to perform operations comprising:
deploying a language model that is configured to respond to prompts from network operators associated with a network;
receiving a prompt from a network operator indicating one or more actions to take based on predetermined trigger events occurring;
determining that a predetermined trigger event occurred indicating a potential security incident;
receiving, by the language model, a description of the potential security incident;
determining, by the language model, indicators of compromise identified in the description;
determining, by the language model, one or more second models to call to analyze the indicators of compromise;
receiving, by the language model and from the one or more second models, information indicating that the potential security incident is a real security incident; and
in response to receiving the information, outputting, by the language model, a prompt to the network operator to approve confirmation of the real security incident.

16. The one or more non-transitory computer-readable media of claim 15, the operations further comprising:
based at least in part on receiving approval from the network operator, calling a third model to update a status of the real security incident to a true positive.

17. The one or more non-transitory computer-readable media of claim 16, wherein the approval from the network operator is automated and does not require user input.

18. The one or more non-transitory computer-readable media of claim 16, wherein the information received from the one or more second models include network devices that are affected by the real security incident, and the operations further comprising:
calling, by the language model, one or more fourth models to call to determine how to contain the real security incident;
receiving, by the language model from the one or more fourth models, information on actions to execute to contain the real security incident including actions to execute to (i) isolate the affected network devices, (ii) disable affected user accounts, or (iii) prevent further damage from the real security incident;
outputting, by the language model, a prompt to the network operator for approval to execute the actions; and
in response to receiving approval, calling one or more fifth models to execute the actions.

19. The one or more non-transitory computer-readable media of claim 18, the operations further comprising:
determining, by the language model, one or more sixth models to call to determine how to eradicate the real security incident;
receiving, by the language model from the one or more sixth models, information on actions to execute to eradicate the real security incident including actions to execute to (i) remove malicious software, (ii) patch vulnerable systems, or (iii) restore affected data;
outputting, by the language model, a prompt to the network operator for approval to execute the actions; and
in response to receiving approval, calling one or more seventh models to execute the actions.

20. The one or more non-transitory computer-readable media of claim 19, the operations further comprising:
determining, by the language model, one or more eighth models to call to determine how to recover from the real security incident;
receiving, by the language model from the one or more eighth models, information on actions to execute to recover from the real security incident including actions to execute to (i) restoring systems to a known good state, and (ii) validating that the real security incident has been resolved;
outputting, by the language model, a prompt to the network operator for approval to execute the actions; and
in response to receiving approval, calling one or more ninth models to execute the actions.
